(19) United States
(12) Patent Application Publication
(10) Pub. No.: US 2023/0337258 A1
(43) Pub. Date: Oct. 19, 2023

(54) METHOD FOR CHANNEL MONITORING, TERMINAL DEVICE, AND NON-TRANSITORY STORAGE MEDIUM

(71) Applicant: BEIJING UNISOC COMMUNICATIONS TECHNOLOGY CO., LTD., Beijing (CN)

(72) Inventor: Huan ZHOU, Beijing (CN)

(21) Appl. No.: 18/336,290

(22) Filed: Jun. 16, 2023

Related U.S. Application Data
(63) Continuation of application No. PCT/CN2021/133759, filed on Nov. 27, 2021.

(30) Foreign Application Priority Data
Dec. 16, 2020 (CN) 202011490434.6

(51) Int. Cl. H04W 72/232; H04W 76/20; H04W 72/1263

(52) U.S. Cl. CPC H04W 72/232; H04W 76/20; H04W 72/1263

(57) ABSTRACT

A method for channel monitoring is provided. The method is applicable to a terminal device accessing a primary cell (PCell) and a secondary cell (SCell) and includes the following. Monitor a physical downlink control channel (PDCCH) in a search space (SS) on the PCell, where the SCell is in a deactivation state or a dormancy state. Receive an SCell-state switching instruction, where the SCell-state switching instruction includes an activation instruction for the SCell or a non-dormancy-state switching instruction for the SCell. Based on the SCell-state switching instruction, perform state switching on the SCell and perform cross-carrier scheduling on the PCell to monitor the PDCCH in an SS on the SCell.

### CROSS-REFERENCE TO RELATED APPLICATION(S)

This application is a continuation application of International Application No. PCT/CN2021/133759, filed on Nov. 27, 2021, which claims priority to Chinese Patent Application No. 202011490434.6, filed on Dec. 16, 2020, both of which are incorporated herein by reference in their entireties.

### TECHNICAL FIELD

This disclosure relates to the field of communication technologies, and in particular, to a method for channel monitoring, a terminal device, and a non-transitory storage medium.

### BACKGROUND

In carrier aggregation (CA), multiple component carriers (CCs) can be aggregated together for information transceiving of a single terminal device, and a relatively high rate can be achieved by increasing available frequency resources for the terminal device, where the CCs may originate from different cells. A case that scheduling grants and transmission data are transmitted on different carriers is referred to as cross-carrier scheduling.

Currently, in CA, only cross-carrier scheduling between secondary cells (SCells) can be supported, and a primary cell (PCell) can perform only self-carrier scheduling, resulting in an insufficient PDCCH capacity on the PCell. On condition that there are no sufficient PDCCH resources for the PCell, problems such as information transmission bottlenecks may occur in a network system, and a network environment is unstable.

### SUMMARY

A method for channel monitoring, a terminal device, and a non-transitory storage medium are provided.

In a first aspect, a method for channel monitoring is provided in implementations of the disclosure. The method is applicable to a terminal device, and the terminal device accesses a primary cell (PCell) and a secondary cell (SCell). The method includes the following. Monitor a physical downlink control channel (PDCCH) in a search space (SS) on the PCell, where the SCell is in a deactivation state or a dormancy state. Receive an SCell-state switching instruction, where the SCell-state switching instruction includes an activation instruction for the SCell or a non-dormancy-state switching instruction for the SCell. Based on the SCell-state switching instruction, perform state switching on the SCell and perform cross-carrier scheduling on the PCell to monitor the PDCCH in an SS on the SCell.

In a second aspect, a terminal device is provided in implementations of the disclosure. The terminal device includes a transceiver, a processor coupled to the transceiver, and a memory storing a computer program which, when executed by the processor, causes the transceiver to perform the following. Monitor a PDCCH in an SS on the PCell, where the SCell is in a deactivation state or a dormancy state. Receive an SCell-state switching instruction, where the SCell-state switching instruction includes an activation instruction for the SCell or a non-dormancy-state switching instruction for the SCell. Based on the SCell-state switching instruction, perform state switching on the SCell and perform cross-carrier scheduling on the PCell to monitor the PDCCH in an SS on the SCell.

In a third aspect, a non-transitory storage medium is provided. The storage medium stores a computer program which, when executed by a processor of a terminal device accessing a PCell and an SCell, causes the terminal device to perform the following. Monitor a PDCCH in an SS on the PCell, where the SCell is in a deactivation state or a dormancy state. Receive an SCell-state switching instruction, where the SCell-state switching instruction includes an activation instruction for the SCell or a non-dormancy-state switching instruction for the SCell. Based on the SCell-state switching instruction, perform state switching on the SCell and perform cross-carrier scheduling on the PCell to monitor the PDCCH in an SS on the SCell.

### BRIEF DESCRIPTION OF THE DRAWINGS

In order to describe technical solutions in implementations of the disclosure more clearly, the following will give a brief introduction to accompanying drawings required for describing implementations. Apparently, the accompanying drawings hereinafter described merely illustrate some implementations of the disclosure. Based on these drawings, those of ordinary skills in the art can also obtain other drawings without creative effort.

FIG. 1 is a schematic diagram of a wireless network architecture provided in implementations of the disclosure.

FIG. 2 is a schematic flow chart illustrating a method for channel monitoring provided in implementations of the disclosure.

FIG. 3 is a schematic diagram illustrating a method for search space set (SSS) determination provided in implementations of the disclosure.

FIG. 4 is a schematic diagram illustrating a method for determining an SSS with cross-carrier provided in implementations of the disclosure.

FIG. 5 is another schematic flow chart illustrating a method for channel monitoring provided in implementations of the disclosure.

FIG. 6 is another schematic flow chart illustrating a method for channel monitoring provided in implementations of the disclosure.

FIG. 7 is a schematic diagram illustrating units of an apparatus for channel monitoring provided in implementations of the disclosure.

FIG. 8 is a simplified schematic structural view of an apparatus for channel monitoring provided in implementations of the disclosure.

### DETAILED DESCRIPTION

The following will describe technical solutions in implementations of the disclosure with reference to accompanying drawings.

In order to better understand implementations of the disclosure, the following will introduce technical terms involved in implementations of the disclosure.

Carrier Aggregation (CA): CA is a technology for increasing a transmission bandwidth, in which two or more component carriers (CCs) may be aggregated together, and all the multiple carriers can serve one terminal device. As such, the terminal device can obtain a relatively wide service bandwidth, and correspondingly achieve a relatively high transmission rate. Each CC may separately correspond to a cell, that is to say, aggregation of a CC can be considered as aggregation of a cell. After the terminal device enters a connected state, the terminal device can communicate with an access network (AN) device via multiple CCs, the AN device can designate a primary component carrier (PCC) for the terminal device, and accordingly, other CCs are referred to as secondary component carriers (SCCs). A serving cell on the PCC is referred to as a primary cell (PCell), and a serving cell on the SCC is referred to as a secondary cell (SCell). In implementations of the disclosure, the SCell may further include a secondary secondary cell (sSCell), and for ease of illustration, sSCell and SCell are collectively referred to as SCell. In cells aggregated by the terminal device, one cell may serve as a PCell, where the terminal device can access the PCell. The other cells may serve as SCells, and the SCells are configured by a network after the terminal device enters the connected state. The network can rapidly activate or deactivate the SCells to meet change in requirements. Different terminal devices may be configured with different cells that serve as PCells, in other words, each terminal device is configured with a PCell.

Cross-carrier scheduling: Cross-carrier scheduling refers to transmit on a designated CC downlink (DL) scheduling information on other CCs. In a CA scenario, scheduling grant may be performed for each carrier, and a case where DL scheduling information and transmission data are transmitted on different carriers is referred to as cross-carrier scheduling. For example, when the SCell performs cross-carrier scheduling on the PCell, the AN device transmits a physical downlink control channel (PDCCH) through the PCell, and transmits through the SCell a physical downlink shared channel (PDSCH) scheduled by the PDCCH.

Search space (SS): In a new radio (NR) system, due to a relatively wide bandwidth (400 MHz at maximum) of the system, if the PDCCH still occupies the whole bandwidth, not only are resources wasted, but blind detection is complicated. In addition, in order to increase system flexibility, a start position of the PDCCH in a time domain can also be configured. That is to say, in the NR system, a user equipment (UE) can successfully decode the PDCCH only if the terminal device knows a position of the PDCCH in a frequency domain and a position of the PDCCH in the time domain. For convenience, the NR system can encapsulate into a control resource set (CORESET) information such as a frequency band occupied by the PDCCH in the frequency domain and the number of orthogonal frequency-division multiplexing (OFDM) symbols occupied by the PDCCH in the time domain, and encapsulate into the SS information such as a serial number of a start OFDM symbol occupied by the PDCCH and a PDCCH monitoring period. In the 5G NR, the SS is classified into two types: common search space (CSS) and UE-specific search space (USS), where the CSS is mainly used for cell access and cell handover, while the USS is used after cell access.

To better understand implementations of the disclosure, a network architecture applicable to implementations of the disclosure is described below.

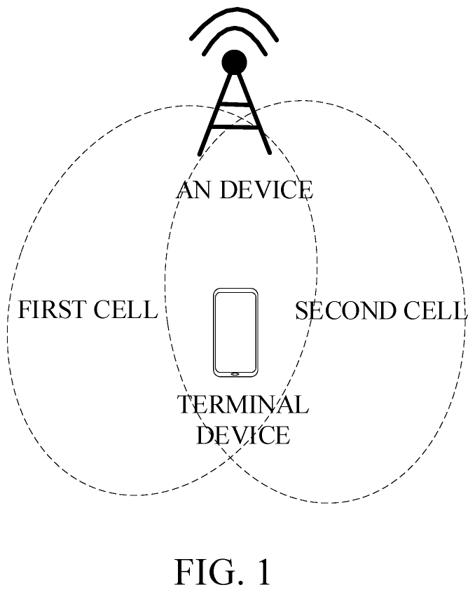

Referring to FIG. 1, FIG. 1 is a schematic diagram of a wireless network architecture provided in implementations of the disclosure. As illustrated in FIG. 1, in the diagram of the wireless network architecture, an AN device and a terminal device are included. The AN device can cover a certain communication range through a first cell and a second cell. One of the first cell and the second cell serves as a PCell, and the other one of the first cell and the second cell serves as an SCell. For example, the first cell serves as a PCell, and the second cell serves as an SCell; or the first cell serves as an SCell, and the second cell serves as a PCell. The terminal device may establish a connection with both the first cell and the second cell through CA, so that the two cells can both serve the terminal device. The terminal device can also aggregate more cells, which is not limited in implementations of the disclosure. As illustrated in FIG. 1, in actual applications, the AN device may include more than two cells. For example, the AN device includes two cells in implementations of the disclosure. The first cell can perform cross-carrier scheduling on the second cell, and the second cell can also perform cross-carrier scheduling on the first cell. When the first cell performs cross-carrier scheduling on the second cell, the AN device transmits the PDCCH through the second cell, and transmits through the first cell the PDSCH scheduled by the PDCCH. The first cell includes a search space set (SSS) for the first cell, and the second cell includes the SSS for the second cell. The first cell performs cross-carrier scheduling on the second cell, that is, the terminal device monitors a PDCCH on the first cell according to an SSS for the second cell.

The AN device involved in implementations of the disclosure is an entity for transmitting or receiving a signal at a network side, can be used for performing mutual conversion between a received air frame and an internet protocol (IP) packet, and serves as a router between the terminal device and the rest of the AN, where the rest of the AN may include an IP network, etc. The AN device can also coordinate management of attributes of an air interface. For example, the AN device may be an evolved Node B (eNB or e-NodeB) in long term evolution (LTE), an NR controller, a gNode B (gNB) in a 5th generation (5G) system, a centralized unit, an NR base station, a radio remote module, a micro base station, a relay, a distributed unit, a transmission reception point (TRP), a transmission point (TP), or any other wireless access devices, which is not limited in implementations of the disclosure.

The terminal device involved in implementations of the disclosure is an entity for receiving or transmitting a signal at a user side. The terminal device can provide voice and/or data connectivity services to a user. For example, the terminal device may be a device with wireless communication functions such as a handheld device, a vehicle-mounted device, and the like. The terminal device may also be other processing devices connected to a wireless modem. The terminal device may communicate with a radio access network (RAN). The terminal device may also be referred to as a wireless terminal, a subscriber unit, a subscriber station, a mobile station, a mobile platform, a remote station, an access point, a remote terminal, an access terminal, a user terminal, a user agent, a user device, a UE, and the like. The terminal device may be a mobile terminal, such as a mobile phone (or referred to as a “cellular” phone), a computer equipped with a mobile terminal, and the like. For example, the terminal device may also be a portable, pocket-sized, handheld, computer-built, or vehicle-mounted mobile device that exchanges language and/or data with the RAN. For example, the terminal device may also be a personal communication service (PCS) phone, a cordless phone, a session initiation protocol (SIP) phone, a wireless local loop (WLL) station, a personal digital assistant (PDA), and the like. Common terminal devices include, for example, a mobile phone, a tablet computer, a notebook computer, a palmtop computer, a mobile internet device (MID), a vehicle, a roadside device, an aircraft, and a wearable device, where the wearable device includes, for example, a smart watch, a smart bracelet, a pedometer, and the like, which are not limited in implementations of the disclosure. The following will describe in detail communication methods and relevant devices provided in the disclosure.

To achieve PDCCH cross-carrier monitoring between an SCell and a PCell, methods and apparatuses for channel monitoring are provided in implementations of the disclosure. The following further introduces in detail the methods and apparatuses for channel monitoring provided in implementations of the disclosure.

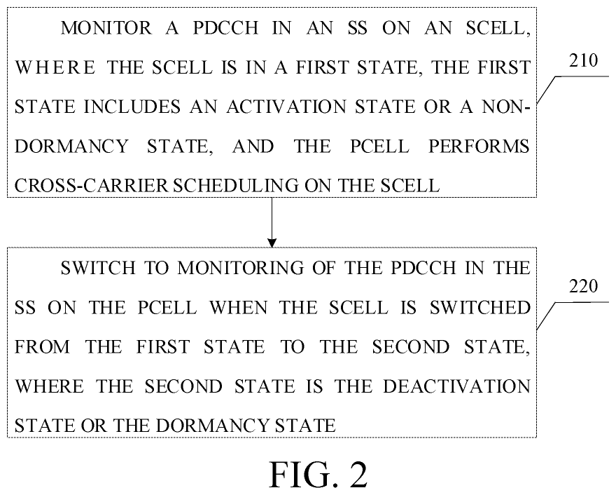

Referring to FIG. 2, FIG. 2 is a schematic flow chart illustrating a method for channel monitoring provided in implementations of the disclosure. As illustrated in FIG. 2, the method for channel monitoring includes the following. The method illustrated in FIG. 2 may be performed by a terminal device or a chip in the terminal device. For example, the method illustrated in FIG. 2 is performed by the terminal device, and includes the following.

210, monitor a PDCCH in an SS on an SCell. The SCell is in a first state, the first state includes an activation state or a non-dormancy state, and the PCell performs cross-carrier scheduling on the SCell.

The PCell performing cross-carrier scheduling on the SCell means that the PDCCH monitored in the SS on the SCell may be a PDCCH on the PCell.

In a possible implementation, when the first state of the SCell is the activation state and the second state of the SCell is a deactivation state, at the initial stage, for example, when the terminal device is on, the SCell may be in the deactivation state, and the terminal device monitors the PDCCH on the PCell in the SS on the PCell. In implementations of the disclosure, unless otherwise specified, a PDCCH refers to a PDCCH on a cell by default. When the terminal device determines that the SCell is in the second state that is the deactivation state, and the terminal device also receives an activation instruction for the SCell through the PCell, the terminal device can switch the SCell from the deactivation state (the second state) to the activation state (the first state) according to the activation instruction. In this way, PDCCH cross-carrier monitoring between the PCell and the SCell can be achieved. The activation instruction may be a medium access control control element (MAC CE), i.e., sSCell activation MAC CE, for activating the SCell. An effective time of the sSCell activation MAC CE may be 3 ms+1 slot after the terminal device transmits a hybrid auto repeat request-acknowledgement (HARQ-ACK) for the MAC CE to the AN device upon reception of the sSCell activation MAC CE. Moreover, after the terminal device receives the sSCell activation MAC CE, the terminal device can also perform SS switching according to the sSCell activation MAC CE. The terminal device switches to monitoring of the PDCCH on the PCell in the SS on the SCell according to the sSCell activation MAC CE. In implementations of the disclosure, the terminal device performing SS switching according to the sSCell activation MAC CE may be referred to as “implicit” switching.

Optionally, except performing SS switching according to the sSCell activation MAC CE, the terminal device can also receive, through the PCell, a first SS switching instruction transmitted by the AN device. The terminal device switches to monitoring of the PDCCH on the PCell in the SS on the SCell according to the first SS switching instruction, i.e., the terminal device executes the monitoring of the PDCCH in the SS on the SCell, which may be referred to as “explicit” switching.

It needs to be noted that, when the first state of the SCell is the activation state and the second state of the SCell is the deactivation state, a second SS switching instruction or the first SS switching instruction received by the terminal device may be determined according to a downlink control information (DCI) format 2_0 or an SS indication in scheduling DCI. The second SS switching instruction may be used for the terminal device to switch from monitoring of the PDCCH in the SS on the SCell to monitoring of the PDCCH in the SS on the PCell. The DCI format 2_0 may be an SS switching instruction for reusing new radio in unlicensed spectrum (NR-U). The DCI format 2_0 may include a bit, where the bit indicates whether to perform SS switching. For example, when the bit is 1, it is determined to switch to an SS on another cell, and when the bit is 0, it is determined not to switch to an SS on another cell. Alternatively, when the bit is 0, it is determined to switch to an SS on an another cell, and when the bit is 1, it is determined not to switch to an SS on an another cell, which is not limited in implementations of the disclosure. The terminal device can also make an existing scheduling DCI to indicate whether to perform SS switching. The scheduling DCI may include the SS indication, where the SS indication may indicate whether to perform SS switching. For example, the terminal device can determine to perform SS switching on condition that the terminal device determines that a frequency domain resource allocation (FDRA) field in a fallback DCI format is fully filled with 1.

In a possible implementation, when the first state of the SCell is the non-dormancy state and the second state of the SCell is a dormancy state, at the initial stage, for example, when the terminal device is on, the SCell may be in the dormancy state, and the terminal device monitors the PDCCH on the PCell in the SS on the PCell. When the terminal device determines that the SCell is in the second state that is the dormancy state, and the terminal device also receives a non-dormancy-state switching instruction for the SCell through the PCell, the terminal device can switch the SCell from the dormancy state (the second state) to the non-dormancy state (the first state) according to the non-dormancy-state switching instruction. In this way, PDCCH cross-carrier monitoring between the PCell and the SCell can be achieved. The non-dormancy-state switching instruction may be dormancy switching DCI. After the terminal device receives the dormancy switching DCI, the terminal device can also perform SS switching according to the dormancy switching DCI. The terminal device switches to monitoring of the PDCCH on the PCell in the SS on the SCell according to the dormancy switching DCI. In implementations of the disclosure, the terminal device performing SS switching according to the dormancy switching DCI may be referred to as “implicit” switching.

Optionally, except performing SS switching according to the dormancy switching DCI, the terminal device can also receive, through the PCell, the first SS switching instruction transmitted by the AN device. The terminal device switches to monitoring of the PDCCH on the PCell in the SS on the SCell according to the first SS switching instruction, i.e., the terminal device executes the monitoring of the PDCCH in the SS on the SCell, which may be referred to as “explicit” switching.

It needs to be noted that, when the first state of the SCell is the non-dormancy state and the second state of the SCell is the dormancy state, the second SS switching instruction or the first SS switching instruction received by the terminal device may be determined according to the dormancy switching DCI or DCI after the dormancy switching DCI.

Optionally, on condition that the second SS switching instruction or the first SS switching instruction is determined according to the dormancy switching DCI, an unoccupied bit(s) in the dormancy switching DCI can indicate whether to perform SS switching. Specifically, the dormancy switching DCI includes at least one of: a modulation and coding scheme (MCS), a new data indicator (NDI), a redundancy version (RV), an HARQ process number, at least one antenna port, a most significant bit (MSB) in a demodulation reference signal (DMRS) sequence initialization field, or a physical uplink control channel (PUCCH) resource indication field. The dormancy switching DCI can be used to determine the second SS switching instruction or the first SS switching instruction. The MCS occupies 5 bits, the NDI occupies 1 bit, the RV occupies 2 bits, the HARQ process number occupies 4 bits, and the at least one antenna port occupies 4 bits.

Optionally, on condition that the second SS switching instruction or the first SS switching instruction is determined according to the dormancy switching DCI, whether to perform SS switching can be indicated by a newly-added bit(s) in the dormancy switching DCI. Specifically, the dormancy switching DCI may include a newly-added bit. The newly-added bit is used to determine the second SS switching instruction or the first SS switching instruction, and the newly-added bit is determined according to higher-layer signaling configuration. If the higher-layer signaling configuration supports SS switching, 1 bit can be newly added in the dormancy switching DCI to indicate whether to perform SS switching. For example, the newly-added bit being 1 may indicate to perform SS switching, and correspondingly, the newly-added bit being 0 may indicate not to perform SS switching. Alternatively, the newly-added bit being 0 may indicate to perform SS switching, and correspondingly, the newly-added bit being 1 may indicate not to perform SS switching, which is not limited in implementations of the disclosure.

Optionally, the terminal device can further determine the second SS switching instruction or the first SS switching instruction according to DCI after the dormancy switching DCI. For example, the terminal device can determine to perform SS switching on condition that the terminal device determines that the FDRA field in the fallback DCI format is fully filled with 1.

It needs to be noted that in the NR system, a method for an SCell to switch from a dormancy like operation to a non-dormancy like operation can be supported. The AN device can transmit a PDCCH to a special cell (Spcell), and use a bit(s) in the PDCCH to indicate (instruct) a certain SCell or several SCell groups to enter the dormancy like operation or the non-dormancy like operation. Specifically, the method includes the following. Outside a discontinuous reception (DRX) active time, use a bitmap with a length of 5 at maximum after a start bit in a DCI format 2_6 to indicate whether SCell groups are to enter a dormancy state, where the number of the SCell groups is the same as the length of the bitmap. In the DRX active time or on condition that no DRX is configured, a bitmap with a length of 5 at maximum is added at an end of a DCI format 1_1 or a DCI format 0_1 to indicate whether SCell groups are to enter the dormancy state, where the number of the SCell groups is the same as the length of the bitmap. Alternatively, a frequency domain allocation field in the DCI format 1-1 is set to be fully filled with a special value, and the MCS, the NDI, the RV, the HARQ process number, the at least one antenna port, and DMRS sequence initialization field are used together to indicate whether each SCell is to enter the dormancy state.

220, switch to monitoring of the PDCCH in the SS on the PCell when the SCell is switched from the first state to the second state, where the second state is the deactivation state or the dormancy state.

In a possible implementation, when the first state of the SCell is the activation state and the second state of the SCell is the deactivation state, in the operation at 210, the terminal device switches from monitoring of the PDCCH on the PCell in the SS on the PCell to monitoring of the PDCCH on the PCell in the SS on the SCell, which is achieved by switching the SCell from the deactivation state (the second state) to the activation state (the first state). When the SCell is switched from the activation state to the deactivation state, the terminal device switches to monitoring of the PDCCH on the PCell in the SS on the PCell. Specifically, on condition that the terminal device receives a deactivation instruction for the SCell through the SCell, the terminal device can switch the SCell from the activation state to the deactivation state according to the deactivation instruction. Furthermore, the terminal device can switch to monitoring of the PDCCH on the PCell in the SS on the PCell in a corresponding “implicit” manner. The deactivation instruction may also be determined according to the sSCell activation MAC CE.

Optionally, after the terminal device switches the SCell from the activation state to the deactivation state according to the deactivation instruction, the terminal device can receive the second SS switching instruction through the SCell, and switch to monitoring of the PDCCH on the PCell in the SS on the PCell according to the second SS switching instruction. When the first state of the SCell is the activation state and the second state of the SCell is the deactivation state, the method for determining the second SS switching instruction is described in detail in the operation at 210, which will not be repeated herein.

In a possible implementation, when the first state of the SCell is the non-dormancy state and the second state of the SCell is the dormancy state, in the operation at 210, the terminal device switches from monitoring of the PDCCH on the PCell in the SS on the PCell to monitoring of the PDCCH on the PCell in the SS on the SCell, which is achieved by switching the SCell from the dormancy state (the second state) to the non-dormancy state (the first state). When the SCell is switched from the non-dormancy state to the dormancy state, the terminal device switches to monitoring of the PDCCH on the PCell in the SS on the PCell. Specifically, on condition that the terminal device receives a dormancy-state switching instruction for the SCell through the SCell, the terminal device can switch the SCell from the non-dormancy state to the dormancy state according to the dormancy-state switching instruction. Furthermore, the terminal device can switch to monitoring of the PDCCH on the PCell in the SS on the PCell in a corresponding “implicit” manner.

Optionally, after the terminal device switches the SCell from the non-dormancy state to the dormancy state according to the dormancy-state switching instruction, the terminal device can receive the second SS switching instruction through the SCell, and switch to monitoring of the PDCCH on the PCell in the SS on the PCell according to the second SS switching instruction. When the first state of the SCell is the non-dormancy state and the second state of the SCell is the dormancy state, the method for determining the second SS switching instruction is described in detail in the operation at 210, which will not be repeated herein.

In a possible implementation, after the PDCCH on the PCell is monitored in the SS on the SCell, on condition that bandwidth part (BWP) switching occurs on the SCell and/or the PCell, a third SS switching instruction transmitted by the AN device can be received. The terminal device can switch to monitoring of the PDCCH on the PCell in the SS on the PCell according to the third SS switching instruction. The third SS switching instruction may be determined according to the DCI format 2_0 or the SS indication in the scheduling DCI. The DCI format 2_0 may include a bit, where the bit indicates whether to perform SS switching. The terminal device can also make an existing scheduling DCI to indicate whether to perform SS switching. The scheduling DCI may include the SS indication, where the SS indication may indicate whether to perform SS switching. For example, a FDRA field in certain DCI can be set to be fully filled with a special value. For example, on condition that the DCI is an indication indicative of only a start position and a length of a resource, the FDRA field can be set to be fully filled with 1 to indicate performing of SS switching; on condition that the DCI is an indication of which bits are in one-to-one correspondence with resource units, the FDRA field can be set to be fully filled with 0 to indicate performing of SS switching. On condition that the DCI can support the above two cases, the FDRA field can be set to be fully filled with 1 or 0 to indicate performing of SS switching.

In a possible implementation, each of the SS on the PCell and the SS on the SCell actually includes at least one search space set (SSS), and each SSS is configured with a group index. The terminal device can know the number of SSSs for monitoring a current serving cell according to searchSpaceGroupIdList-r16. The terminal device can be provided with a timer according to searchSpaceSwitchTimer-rl6. The terminal device decrements a timer value by 1 after each slot in an active DL_BWP in the serving cell, and in the slot, the terminal device performs PDCCH monitoring to detect the DCI format 2_0. The terminal device can determine how to perform SSS monitoring according to the DCI format 2_0.

In a possible implementation, the terminal device is configured with the DCI format 2_0 that contains an indication field for triggering SS switching.

Optionally, on condition that the indication field for triggering SS switching is fully filled with 0 and the terminal device does not monitor SSSs with group index 0, the terminal device starts monitoring the SSSs with the group index 0, and stops monitoring a PDCCH according to SSSs with group index 1 in a next slot after at least P1 symbols.

Optionally, on condition that the indication field for triggering SS switching is fully filled with 1 and the terminal device does not monitor the SSSs with the group index 1, the terminal device starts monitoring the SSSs with the group index 1 in a next slot after at least P1 symbols, stops monitoring a PDCCH according to the SSSs with the group index 0, and sets a value of the searchSpaceSwitchTimer-rl6 to a configured value, where the configured value is configured by the terminal device or the AN device.

Optionally, in the case where the terminal device is monitoring a PDCCH according to the SSSs with the group index 1, on condition that the terminal device does not monitor the SSSS with the group index 1 when searchSpaceSwitch Timer-rl6 expires or a next slot after at least P1 symbols of a remaining channel occupancy duration indicated by the DCI format 2_0 reaches, the terminal device starts monitoring the PDCCH according to the SSSs with the group index 0, and stops monitoring the PDCCH according to the SSSS with the group index 1.

In a possible implementation, the terminal device is configured with no indication for triggering SS switching.

Optionally, on condition that a PDCCH is monitored by the terminal device according to the SSSs with the group index 0, the terminal device starts monitoring the SSSs with the group index 1, and stops monitoring the PDCCH according to the SSSs with the group index 0 in a next slot after P2 symbols. The terminal device sets the value of the searchSpaceSwitch Timer-rl6 to the configured value.

Optionally, in the case where a PDCCH is monitored by the terminal device according to the SSSS with the group index 1, when the searchSpaceSwitch Timer-rl6 expires or a next slot after at least P2 symbols of a remaining channel occupancy duration indicated by the DCI format 2_0 reaches, the terminal device starts monitoring the SSSs with the group index 0 and stops monitoring the PDCCH according to the SSSS with the group index 1.

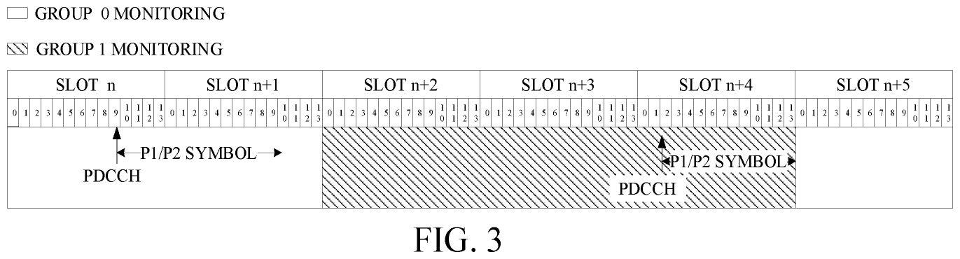

For example, as illustrated in FIG. 3, on condition that the DCI format 2_0 includes an indication field for triggering SS switching and the indication field for triggering SS switching is fully filled with 0, the terminal device can monitor a PDCCH according to the SSSs with the group index 0 in slot n. After at least P1 symbols, the terminal device starts monitoring the PDCCH according to the SSSs with the group index 1, and stops monitoring the PDCCH according to the SSSs with the group index 0. Alternatively, on condition that the DCI format 2_0 includes no indication field for triggering SS switching, since the PDCCH is monitored by the terminal device according to the SSSS with the group index 0 in the ninth slot in the slot n, the terminal device can start monitoring the PDCCH according to the SSSs with the group index 1. Furthermore, the terminal device stops monitoring the PDCCH according to the SSSs with the group index 0 in a next slot that is at least P2 symbols after the ninth slot in the slot n.

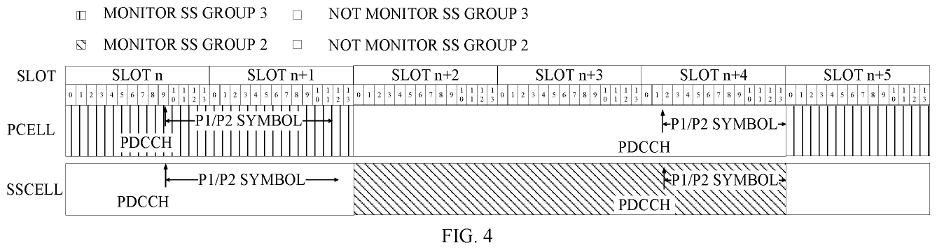

The solutions of implementations of the disclosure will be described in detail below according to examples illustrated in FIG. 4. As illustrated in FIG. 4, during a period from slot 1 to slot n+1, the terminal device monitors a PDCCH on the PCell according to an SSS for the PCell. Furthermore, monitoring is performed according to an SSS with group index 3 for the PCell, and the SSS with the group index 3 may be determined according to the DCI format 2_0 received by the terminal device. In this case, the SCell is in the deactivation state or the dormancy state, so the SCell cannot perform cross-carrier scheduling on the PCell. The PDCCH is monitored by the terminal device in the ninth slot in the slot n, and the terminal device needs to switch to monitoring of the PDCCH on the PCell according to another SSS after at least P1 symbols or P2 symbols. However, in the last slot in the slot n+1, the SCell is switched from the deactivation state to the activation state, or switched from the dormancy state to the non-dormancy state, then the SCell can perform cross-carrier scheduling on the PCell, and the terminal device can monitor the PDCCH on the PCell according to the SSS for the SCell. Specifically, the PDCCH on the PCell is monitored according to an SSS with group index 2 for the SCell. The SSS with the group index 2 may be determined according to the DCI format 2_0 received by the terminal device. In the second slot in slot n+4, the PDCCH is monitored by the terminal device the terminal device needs to switch to monitoring of the PDCCH on the PCell in another SSS after P1 symbols or P2 symbols. In the last slot in the slot n+4, when the SCell is switched from the activation state to the deactivation state or switched from the non-dormancy state to the dormancy state, or BWP switching occurs on at least one of the PCell or the SCell, the terminal device switches back to monitoring of the PDCCH according to the SSS for the PCell.

It needs to be noted that, the SCell can perform cross-carrier scheduling on the PCell is mainly described in implementations of the disclosure.

According to implementations of the disclosure, when the SCell is in the activation state or the non-dormancy state, the SCell can perform cross-carrier scheduling on the PCell, so that the terminal device can monitor the PDCCH on the PCell in the SS on the SCell. When the SCell is switched from the activation state to the deactivation state or switched from the non-dormancy state to the dormancy state, or BWP switching occurs on at least one of the PCell or the SCell, the terminal device switches back to monitoring of the PDCCH according to the SSS for the PCell. With the method, PDCCH cross-carrier monitoring between the SCell and the PCell can be achieved.

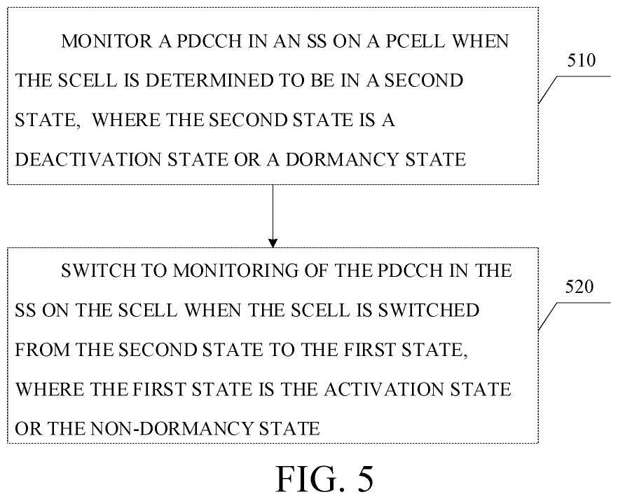

Referring to FIG. 5, FIG. 5 is another schematic flow chart illustrating a method for channel monitoring provided in implementations of the disclosure. As illustrated in FIG. 5, the method for channel monitoring includes the following. The method illustrated in FIG. 5 may be performed by a terminal device or a chip in the terminal device. For example, the method illustrated in FIG. 5 is performed by the terminal device, and includes the following.

510, monitor a PDCCH in an SS on a PCell when the SCell is determined to be in a second state. The second state is a deactivation state or a dormancy state.

When the terminal device determines that the SCell is in the second state, it indicates that the SCell cannot perform cross-carrier scheduling on the PCell in this case, and thus the terminal device can monitor the PDCCH on the PCell only in the SS on the PCell.

In a possible implementation, when the first state of the SCell is the activation state and the second state of the SCell is the deactivation state, before the terminal device determines that the SCell is in the deactivation state, the SCell may be in the activation state, thus the SCell can perform cross-carrier scheduling on the PCell, and the terminal device can monitor the PDCCH on the PCell in the SS on the SCell. The terminal device can switch the SCell from the activation state to the deactivation state upon reception of a deactivation instruction for the SCell through the SCell. Specifically, the terminal device can execute the monitoring of the PDCCH in the SS on the PCell according to the deactivation instruction (“implicit” switching) or a fourth SS switching instruction (“explicit” switching) received by the SCell.

It needs to be noted that, when the first state of the SCell is the activation state and the second state of the SCell is the deactivation state, the activation instruction and the deactivation instruction may be determined according to an sSCell activation MAC CE, and the fourth SS switching instruction and the fifth SS switching instruction may be determined according to a DCI format 2_0 or an SS indication in scheduling DCI. The activation instruction is used to switch the SCell from the deactivation state to the activation state, and the fifth SS switching instruction is used for the terminal device to switch from monitoring of the PDCCH in the SS on the PCell to monitoring of the PDCCH in the SS on the SCell. The method for determining the fourth SS switching instruction and the fifth SS switching instruction when the first state of the SCell is the activation state and the second state of the SCell is the deactivation state is the same as the method for determining the first SS switching instruction and the second SS switching instruction when the first state of the SCell is the activation state and the second state of the SCell is the deactivation state, which is not repeated herein.

In a possible implementation, when the first state of the SCell is the non-dormancy state and the second state of the SCell is the dormancy state, before the terminal device determines that the SCell is in the deactivation state, the SCell may be in the non-dormancy state, thus the SCell can perform cross-carrier scheduling on the PCell, and the terminal device can monitor the PDCCH on the PCell in the SS on the SCell. The terminal device can switch the SCell from the dormancy state to the non-dormancy state upon reception of a dormancy-state switching instruction for the SCell through the SCell. Specifically, the terminal device can execute the monitoring of the PDCCH in the SS on the PCell according to the non-dormancy-state switching instruction (“implicit” switching) or the fourth SS switching instruction (“explicit” switching) received by the SCell.

It needs to be noted that, when the first state of the SCell is the non-dormancy state and the second state of the SCell is the dormancy state, the dormancy-state switching instruction and the non-dormancy-state switching instruction may be determined according to dormancy switching DCI, and the fourth SS switching instruction and the fifth SS switching instruction may be determined according to the dormancy switching DCI or an SS indication in scheduling DCI. The dormancy switching DCI includes at least one of: an MCS, an NDI, an RV, an HARQ process number, at least one antenna port, an MSB in a DMRS sequence initialization field, or a PUCCH resource indication field. The dormancy switching DCI can be used to determine the fourth SS switching instruction or the fifth SS switching instruction. Alternatively, the dormancy switching DCI may include a newly-added bit. The newly-added bit is used to determine the fourth SS switching instruction or the fifth SS switching instruction, and the newly-added bit is determined according to higher-layer signaling configuration. The method for determining the fourth SS switching instruction and the fifth SS switching instruction when the first state of the SCell is the non-dormancy state and the second state of the SCell is the dormancy state is the same as the method for determining the first SS switching instruction and the second SS switching instruction when the first state of the SCell is the non-dormancy state and the second state of the SCell is the dormancy state, which is not repeated herein.

520, switch to monitoring of the PDCCH in the SS on the SCell when the SCell is switched from the second state to the first state. The first state is the activation state or the non-dormancy state.

In a possible implementation, specifically, when the first state of the SCell is the activation state and the second state of the SCell is the deactivation state, the terminal device can switch the SCell from the deactivation state to the activation state upon reception of an activation instruction for the SCell through the PCell. The terminal device can switch to monitoring of the PDCCH on the PCell in the SS on the SCell according to the activation instruction (“implicit” switching), or switch to monitoring of the PDCCH in the SS on the SCell according to the fifth SS switching instruction received through the SCell (“explicit” switching).

In a possible implementation, specifically, when the first state of the SCell is the non-dormancy state and the second state of the SCell is the dormancy state, the terminal device can switch the SCell from the dormancy state to the non-dormancy state upon reception of non-dormancy-state switching instruction for the SCell through the PCell. The terminal device can switch to monitoring of the PDCCH on the PCell in the SS on the SCell according to the non-dormancy-state switching instruction (“implicit” switching), or switch to monitoring of the PDCCH in the SS on the SCell according to the fifth SS switching instruction received through the SCell (“explicit” switching).

In implementations of the disclosure, when the SCell is in the deactivation state or the dormancy state, the SCell cannot perform cross-carrier scheduling on the PCell, so that the terminal device can monitor the PDCCH on the PCell only in the SS on the PCell. When the SCell is switched from the deactivation state to the activation state, or switched from the dormancy state to the non-dormancy state, the terminal device can switch to monitoring of the PDCCH according to the SSS for the SCell. With the method, PDCCH cross-carrier monitoring between the SCell and the PCell can be achieved.

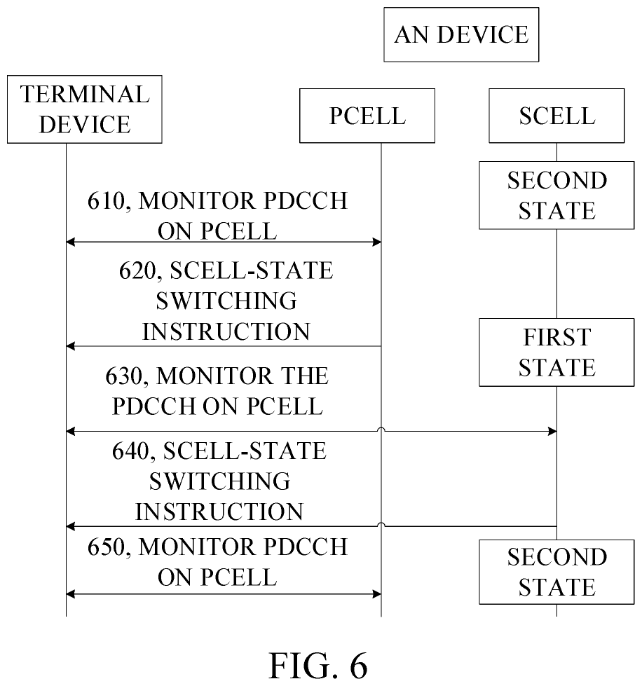

Referring to FIG. 6, FIG. 6 is another schematic flow chart illustrating a method for channel monitoring provided in implementations of the disclosure. When a terminal device executes the process illustrated in FIG. 6, the method includes the following.

610, monitor a PDCCH on a PCell in an SS on the PCell.

In this case, an SCell is in a second state, and the second state is a deactivation state or a dormancy state. In this case, the SCell cannot perform cross-carrier scheduling on the PCell, and thus the terminal device can monitor the PDCCH only in an SS on a self-cell (the PCell).

620, receive through the PCell an SCell-state switching instruction transmitted by an AN device.

The terminal device can switch the SCell from the second state to a first state according to the SCell-state switching instruction. The SCell-state switching instruction may include an activation instruction for the SCell, a deactivation instruction for the SCell, a dormancy-state switching instruction for the SCell, and a non-dormancy-state switching instruction for the SCell. In the operation at 620, the SCell-state switching instruction may be the activation instruction for the SCell or the non-dormancy-state switching instruction for the SCell. The terminal device can switch the SCell from the deactivation state to the activation state according to the activation instruction for the SCell, or switch the SCell from the dormancy state to the non-dormancy state according to the non-dormancy-state switching instruction for the SCell.

630, monitor the PDCCH on the PCell in an SS on the SCell.

When the SCell is in the first state, the SCell can perform cross-carrier scheduling on the PCell, and the terminal device can monitor the PDCCH on the PCell in the SS on the SCell.

640, receive through the SCell the SCell-state switching instruction transmitted by the AN device.

The terminal device can switch the SCell from the first state to the second state according to the SCell-state switching instruction. In the operation at 640, the SCell-state switching instruction may be the deactivation instruction for the SCell or the dormancy-state switching instruction for the SCell. The terminal device can switch the SCell from the activation state to the deactivation state according to the deactivation instruction for the SCell, or switch the SCell from the non-dormancy state to the dormancy state according to the dormancy-state switching instruction for the SCell.

650, switch back to monitoring of the PDCCH on the PCell in the SS on the PCell.

When the SCell is in the second state, the SCell cannot perform cross-carrier scheduling on the PCell, and the terminal device needs to switch back to monitoring of the PDCCH on the PCell in the SS on the PCell.

In addition, when BWP switching occurs on the PCell and/or the SCell, the terminal device also needs to switch back to monitoring of the PDCCH on the PCell in the SS on the PCell.

In implementations of the disclosure, when the SCell is in the activation state or the non-dormancy state, the SCell can perform cross-carrier scheduling on the PCell, and further the terminal device can monitor the PDCCH on the PCell in the SS on the SCell. When the SCell is in the deactivation state or the dormancy state, the SCell cannot perform cross-carrier scheduling on the PCell, and further the terminal device needs to switch back to the SS on the PCell to monitor the PDCCH on the PCell. With the method, PDCCH cross-carrier monitoring between the SCell and the PCell can be achieved.

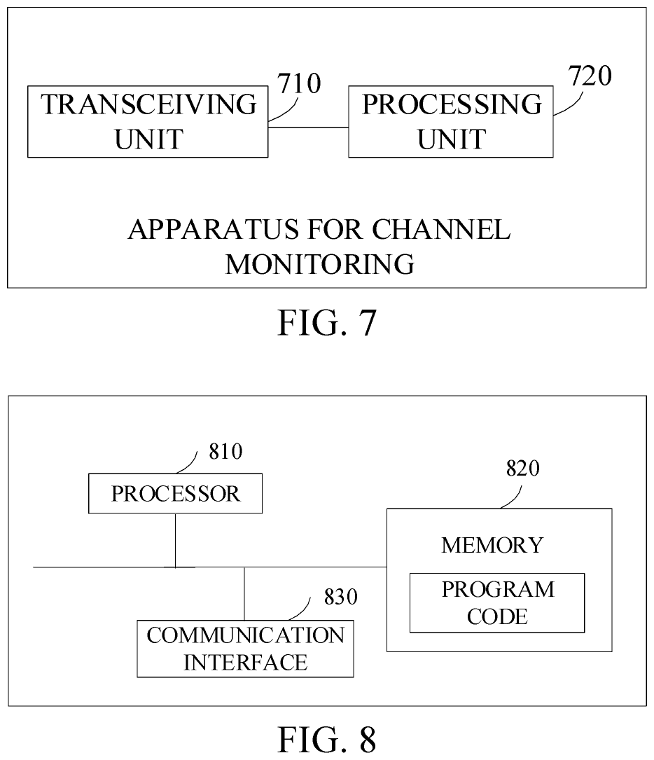

Referring to FIG. 7, FIG. 7 is a schematic diagram illustrating units of an apparatus for channel monitoring provided in implementations of the disclosure. The apparatus for channel monitoring illustrated in FIG. 7 can be configured to perform part or all of the functions in the foregoing method implementations described in FIG. 2, FIG. 5, and FIG. 6. The apparatus may be a terminal device, an apparatus in the terminal device, or an apparatus that can be matched with the terminal device for use.

A logical structure of the apparatus includes a transceiving unit 710 and a processing unit 720. When the apparatus is applicable to the terminal device, the apparatus includes the transceiving unit 710 and the processing unit 720. The transceiving unit 710 is configured to monitor a PDCCH in an SS on an SCell. The SCell is in a first state. The first state includes an activation state or a non-dormancy state, and a PCell performs cross-carrier scheduling on the SCell. The processing unit 720 is configured to switch to monitoring of the PDCCH in an SS on the PCell when the SCell is switched from the first state to a second state. The second state is a deactivation state or a dormancy state.

In a possible implementation, the processing unit 720 is further configured to switch the SCell from the deactivation state to the activation state when the second state that the SCell is in is determined to be the deactivation state and an activation instruction for the SCell is received through the PCell, prior to monitoring the PDCCH in the SS on the SCell. The transceiving unit 710 is further configured to receive a first SS switching instruction through the PCell, and execute the monitoring of the PDCCH in the SS on the SCell according to the first SS switching instruction.

In a possible implementation, the processing unit 720 is further configured to switch the SCell from the activation state to the deactivation state upon reception of a deactivation instruction for the SCell through the SCell. The transceiving unit 710 is further configured to receive a second SS switching instruction through the SCell. The processing unit 720 is further configured to switch to monitoring of the PDCCH in the SS on the PCell according to the second SS switching instruction.

In a possible implementation, the second SS switching instruction or the first SS switching instruction is determined according to a DCI format 2_0 or an SS indication in scheduling DCI.

In a possible implementation, the processing unit 720 is further configured to switch the SCell from the dormancy state to the non-dormancy state when the second state that the SCell is in is determined to be the dormancy state and a non-dormancy-state switching instruction for the SCell is received through the PCell, prior to monitoring the PDCCH in the SS on the SCell. The transceiving unit 710 is further configured to receive a first SS switching instruction through the PCell. The processing unit 720 is further configured to execute the monitoring of the PDCCH in the SS on the SCell according to the first SS switching instruction.

In a possible implementation, the processing unit 720 is further configured to switch the SCell from the non-dormancy state to the dormancy state upon reception of a dormancy-state switching instruction for the SCell through the SCell. The transceiving unit 710 is further configured to receive a second SS switching instruction through the SCell. The processing unit 720 is further configured to switch to monitoring of the PDCCH in the SS on the PCell according to the second SS switching instruction.

In a possible implementation, the non-dormancy-state switching instruction or the dormancy-state switching instruction is determined according to dormancy switching DCI, and the second SS switching instruction or the first SS switching instruction is determined according to the dormancy switching DCI or an SS indication in scheduling DCI.

In a possible implementation, the dormancy switching DCI includes at least one of: an MCS, an NDI, an RV, an HARQ process number, at least one antenna port, an MSB in a DMRS sequence initialization field, or a PUCCH resource indication field. The dormancy switching DCI is used to determine the second SS switching instruction or the first SS switching instruction.

In a possible implementation, the dormancy switching DCI includes a newly-added bit, the newly-added bit is used to determine the second SS switching instruction or the first SS switching instruction, and the newly-added bit is determined according to higher-layer signaling configuration.

In a possible implementation, the transceiving unit 710 is further configured to receive a third SS switching instruction on condition that BWP switching occurs on the SCell and/or the PCell, subsequent to monitoring the PDCCH in the SS on the SCell. The third SS switching instruction is determined according to DCI format 2_0 or an SS indication in scheduling DCI. The processing unit 720 is further configured to switch to monitoring of the PDCCH in the SS on the PCell according to the third SS switching instruction.

In the case where the apparatus is applicable to the terminal device, the apparatus may further include a transceiving unit 710 and a processing unit 720. The transceiving unit 710 is configured to monitor a PDCCH in an SS on the PCell when the SCell is determined to be in a second state, where the second state is a deactivation state or a dormancy state. The processing unit 720 is configured to switch to monitoring of the PDCCH in an SS on the SCell when the SCell is switched from the second to a first state, where the first state is an activation state or a non-dormancy state.

In a possible implementation, the processing unit 720 is further configured to switch the SCell from the activation state to the deactivation state when the first state that the SCell is in is determined to be the activation state and a deactivation instruction for the SCell is received through the SCell, prior to monitoring the PDCCH in the SS on the PCell when the SCell is determined to be in the second state. The transceiving unit 710 is further configured to receive a fourth SS switching instruction through the SCell, and execute the monitoring of the PDCCH in the SS on the PCell according to the fourth SS switching instruction.

In a possible implementation, the processing unit 720 is further configured to switch the SCell from the deactivation state to the activation state upon reception of an activation instruction for the SCell through the PCell. The transceiving unit 710 is further configured to receive a fifth SS switching instruction through the PCell. The processing unit 720 is further configured to switch to monitoring of the PDCCH in the SS on the SCell according to the fifth SS switching instruction.

In a possible implementation, the fourth SS switching instruction or the fifth SS switching instruction is determined according to a DCI format 2_0 or an SS indication in scheduling DCI.

In a possible implementation, the processing unit 720 is further configured to switch the SCell from the non-dormancy state to the dormancy state when the first state that the SCell is in is determined to be the non-dormancy state and a dormancy-state switching instruction for the SCell is received through the SCell, prior to monitoring the PDCCH in the SS on the PCell when the SCell is determined to be in the second state. The transceiving unit 710 is further configured to receive a fourth SS switching instruction through the SCell. The processing unit 720 is further configured to execute the monitoring of the PDCCH in the SS on the PCell according to the fourth SS switching instruction.

In a possible implementation, the processing unit 720 is further configured to switch the SCell from the dormancy state to the non-dormancy state upon reception of a non-dormancy-state switching instruction for the SCell through the PCell. The transceiving unit 710 is further configured to receive a fifth SS switching instruction through the PCell. The processing unit 720 is further configured to switch to monitoring of the PDCCH in the SS on the SCell according to the fifth SS switching instruction.

In a possible implementation, the non-dormancy-state switching instruction or the dormancy-state switching instruction is determined according to dormancy switching DCI, and the fourth SS switching instruction or the fifth SS switching instruction is determined according to the dormancy switching DCI or an SS indication in scheduling DCI.

In a possible implementation, the dormancy switching DCI includes at least one of: an MCS, an NDI, an RV, an HARQ process number, at least one antenna port, an MSB in a DMRS sequence initialization field, or a PUCCH resource indication field. The dormancy switching DCI is used to determine the fourth SS switching instruction or the fifth SS switching instruction.

Referring to FIG. 8, FIG. 8 is a simplified schematic structural view of an apparatus for channel monitoring provided in implementations of the disclosure. The apparatus includes a processor 810, a memory 820, and a communication interface 830. The processor 810, the memory 820, and the communication interface 830 are connected to each other via one or more communication buses.

The processor 810 is configured to support the apparatus for channel monitoring to perform functions corresponding to the methods in FIG. 2, FIG. 5, and FIG. 6. It can be understood that in implementations of the disclosure, the processor 810 may be a central processing unit (CPU). The processor may also be other general-purpose processors, a digital signal processor (DSP), an application specific integrated circuit (ASIC), a field programmable gate array (FPGA), other programmable logic devices, discrete gates or transistor logic devices, or discrete hardware components. The general-purpose processor may be a microprocessor, or the processor may be any conventional processor or the like.

The memory 820 is configured to store program codes. The memory 820 in implementations of the disclosure may be a volatile memory or a non-volatile memory, or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory can be a random access memory (RAM) that acts as an external cache. By way of example but not limitation, many forms of RAM are available, such as a static random access memory (SRAM), a dynamic random access memory (DRAM), a synchronous dynamic random access memory (SDRAM), an enhanced SDRAM (ESDRAM), a synclink dynamic random access memory (SLDRAM), and a direct rambus random access memory (DRRAM).

The communication interface 830 is configured to receive and transmit data, information, messages, and the like, and may also be described as a transceiver, a transceiving circuit, and the like.

In implementations of the disclosure, the processor 810 is configured to invoke the program codes stored in the memory 820 to perform the following, in the case where the apparatus for channel monitoring is applicable to the terminal device. Control the communication interface 830 to monitor a PDCCH in a search space SS on the SCell, where the SCell is in a first state, the first state includes an activation state or a non-dormancy state, and the PCell performs cross-carrier scheduling on the SCell. Switch to monitoring of the PDCCH in an SS on the PCell when the SCell is switched from the first state to a second state, where the second state is a deactivation state or a dormancy state.

In a possible implementation, the processor 810 is configured to invoke the program codes stored in the memory 820 to perform the following, prior to monitoring the PDCCH in the SS on the SCell. Switch the SCell from the deactivation state to the activation state, when the second state that the SCell is in is determined to be the deactivation state and an activation instruction for the SCell is received through the PCell. Control the communication interface 830 to receive a first SS switching instruction through the PCell. Execute the monitoring of the PDCCH in the SS on the SCell according to the first SS switching instruction.

In a possible implementation, the processor 810 is configured to invoke the program codes stored in the memory 820 to perform the following. Switch the SCell from the activation state to the deactivation state upon reception of a deactivation instruction for the SCell through the SCell. Control the communication interface 830 to receive a second SS switching instruction through the SCell. Switch to monitoring of the PDCCH in the SS on the PCell according to the second SS switching instruction.

In a possible implementation, the second SS switching instruction or the first SS switching instruction is determined according to a DCI format 2_0 or an SS indication in scheduling DCI.

In a possible implementation, the processor 810 is configured to invoke the program codes stored in the memory 820 to perform the following, prior to monitoring the PDCCH in the SS on the SCell. Switch the SCell from the dormancy state to the non-dormancy state, when the second state that the SCell is in is determined to be the dormancy state and a non-dormancy-state switching instruction for the SCell is received through the PCell. Control the communication interface 830 to receive a first SS switching instruction through the PCell. Execute the monitoring of the PDCCH in the SS on the SCell according to the first SS switching instruction.

In a possible implementation, the processor 810 is configured to invoke the program codes stored in the memory 820 to perform the following. Switch the SCell from the non-dormancy state to the dormancy state upon reception of a dormancy-state switching instruction for the SCell through the SCell. Control the communication interface 830 to receive a second SS switching instruction through the SCell. Switch to monitoring of the PDCCH in the SS on the PCell according to the second SS switching instruction.

In a possible implementation, the non-dormancy-state switching instruction or the dormancy-state switching instruction is determined according to dormancy switching DCI, and the second SS switching instruction or the first SS switching instruction is determined according to the dormancy switching DCI or an SS indication in scheduling DCI.

In a possible implementation, the dormancy switching DCI includes at least one of: an MCS, an NDI, an RV, an HARQ process number, at least one antenna port, an MSB in a DMRS sequence initialization field, or a PUCCH resource indication field. The dormancy switching DCI is used to determine the second SS switching instruction or the first SS switching instruction.

In a possible implementation, the dormancy switching DCI includes a newly-added bit, the newly-added bit is used to determine the second SS switching instruction or the first SS switching instruction, and the newly-added bit is determined according to higher-layer signaling configuration.

In a possible implementation, the processor 810 is configured to invoke the program codes stored in the memory 820 to perform the following, subsequent to monitoring the PDCCH in the SS on the SCell. Control the communication interface 830 to receive a third SS switching instruction on condition that BWP switching occurs on the SCell and/or the PCell, where the third SS switching instruction is determined according to DCI format 2_0 or an SS indication in scheduling DCI. Switch to monitoring of the PDCCH in the SS on the PCell according to the third SS switching instruction.

In implementations of the disclosure, the processor 810 can be configured to invoke the program codes stored in the memory 820 to perform the following, in the case the apparatus for channel monitoring is applicable to the terminal device. Control the communication interface 830 to monitor a PDCCH in an SS on the PCell when the SCell is determined to be in a second state, where the second state is a deactivation state or a dormancy state. Switch to monitoring of the PDCCH in an SS on the SCell when the SCell is switched from the second to a first state, where the first state is an activation state or a non-dormancy state.

In a possible implementation, the processor 810 is configured to invoke the program codes stored in the memory 820 to perform the following, prior to monitoring the PDCCH in the SS on the PCell when the SCell is determined to be in the second state. Switch the SCell from the activation state to the deactivation state, when the first state that the SCell is in is determined to be the activation state and a deactivation instruction for the SCell is received on the SCell. Control the communication interface 830 to receive a fourth SS switching instruction through the SCell. Execute the monitoring of the PDCCH in the SS on the PCell according to the fourth SS switching instruction.

In a possible implementation, the processor 810 is configured to invoke the program codes stored in the memory 820 to perform the following. Switch the SCell from the deactivation state to the activation state upon reception of an activation instruction for the SCell on the PCell. Control the communication interface 830 to receive a fifth SS switching instruction through the PCell. Switch to monitoring of the PDCCH in the SS on the SCell according to the fifth SS switching instruction.

In a possible implementation, the fourth SS switching instruction or the fifth SS switching instruction is determined according to a DCI format 2_0 or an SS indication in scheduling DCI.

In a possible implementation, the processor 810 is configured to invoke the program codes stored in the memory 820 to perform the following, prior to monitoring the PDCCH in the SS on the PCell when the SCell is determined to be in the second state. Switch the SCell from the non-dormancy state to the dormancy state, when the first state that the SCell is in is determined to be the non-dormancy state and a dormancy-state switching instruction for the SCell is received through the SCell. Control the communication interface 830 to receive a fourth SS switching instruction through the SCell. Execute the monitoring of the PDCCH in the SS on the PCell according to the fourth SS switching instruction.

In a possible implementation, the processor 810 is configured to invoke the program codes stored in the memory 820 to perform the following. Switch the SCell from the dormancy state to the non-dormancy state upon reception of a non-dormancy-state switching instruction for the SCell through the PCell. Control the communication interface 830 to receive a fifth SS switching instruction through the PCell. Switch to monitoring of the PDCCH in the SS on the SCell according to the fifth SS switching instruction.

In a possible implementation, the non-dormancy-state switching instruction or the dormancy-state switching instruction is determined according to dormancy switching DCI, and the fourth SS switching instruction or the fifth SS switching instruction is determined according to the dormancy switching DCI or an SS indication in scheduling DCI.

In a possible implementation, the dormancy switching DCI includes at least one of: an MCS, an NDI, an RV, an HARQ process number, at least one antenna port, an MSB in a DMRS sequence initialization field, or a PUCCH resource indication field. The dormancy switching DCI is used to determine the fourth SS switching instruction or the fifth SS switching instruction.

Each module/unit included in each apparatus or product described in the foregoing implementations may be a software module/unit, a hardware module/unit, a software module/unit, or a hardware module/unit. For example, with regard to various apparatuses and products applied to or integrated in a chip, various modules/units contained therein can all be realized by means of hardware, such as a circuit, or at least some of the modules/units can be realized by means of a software program running on a processor integrated inside the chip, and the remaining (if any) part of the modules/units can be realized by means of hardware, such as a circuit. With regard to various apparatuses and products applied to or integrated in a chip module, various modules/units contained therein can all be realized by means of hardware, such as a circuit. Different modules/units may be located in the same component (e. g., chip, circuit module, etc.) of a chip module or in different components. Alternatively, at least part of the modules/units may be implemented using a software program running on a processor integrated within the chip module. The rest (if any) of the modules/units may be implemented by hardware such as circuits. With regard to various apparatuses and products applied to or integrated in a terminal device, various modules/units contained therein can all be realized by means of hardware, such as a circuit. Different modules/units may be located in the same component (for example, a chip, a circuit module, and so on) or different components in the terminal device. Alternatively, at least some of the modules/units may be implemented by using a software program running on a processor integrated inside the terminal device. The rest (if any) of the modules/units may be implemented by hardware such as circuits.

It needs to be noted that, in the foregoing implementations, the illustration of each implementation has its own emphasis. For the parts not described in detail in a certain implementation, reference may be made to related descriptions in other implementations.

The operations of the methods of the implementations of the disclosure can be adjusted, combined, and deleted according to actual needs.

The modules or units of the processing devices of the implementations of the disclosure can be combined, divided, and deleted according to actual needs.

All or part of the above implementations can be implemented through software, hardware, firmware, or any other combination thereof. When implemented by software, all or part of the above functions can be implemented in the form of a computer program product. The computer program product includes one or more computer instructions. When the computer program instructions are loaded and executed on a computer, all or part of the processes or functions of the implementations of the disclosure are performed. The computer can be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instruction can be transmitted from one web site, computer, server, or data center to another web site, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer-accessible usable-medium or a data storage device such as a server, a data center, or the like which is integrated with one or more usable media. The usable medium can be a magnetic medium (such as a soft disc, a storage disc, or a magnetic tape), an optical medium (such as a digital video disc (DVD)), or a semiconductor medium (such as a solid state disk (SSD)), etc.

Finally, it should be noted that the foregoing implementations are merely intended for describing the technical solutions of the disclosure rather than limiting the disclosure. Although the disclosure is described in detail with reference to the foregoing implementations, those of ordinary skill in the art should understand that they may still make modifications to the technical solutions described in the foregoing embodiments, or make equivalent replacements to some or all technical features thereof; These modifications or replacements do not make the essence of the corresponding technical solutions depart from the scope of the technical solutions of the embodiments of the present application.

What is claimed is:

1. A method for channel monitoring, applicable to a terminal device, the terminal device accessing a primary cell (PCell) and a secondary cell (SCell), and the method comprising:
monitoring a physical downlink control channel (PDCCH) in a search space (SS) on the PCell, the SCell being in a deactivation state or a dormancy state;
receiving an SCell-state switching instruction, the SCell-state switching instruction comprising an activation instruction for the SCell or a non-dormancy-state switching instruction for the SCell; and
based on the SCell-state switching instruction, performing state switching on the SCell and performing cross-carrier scheduling on the PCell to monitor the PDCCH in an SS on the SCell.

2. The method of claim 1, wherein based on the SCell-state switching instruction, performing state switching on the SCell and performing cross-carrier scheduling on the PCell to monitor the PDCCH in the SS on the SCell, comprise:
when the SCell is determined to be in the deactivation state and the activation instruction for the SCell is received, switching the SCell from the deactivation state to an activation state and performing cross-scheduling on the PCell to monitor the PDCCH in the SS on the SCell.

3. The method of claim 1, wherein based on the SCell-state switching instruction, performing state switching on the SCell and performing cross-carrier scheduling on the PCell to monitor the PDCCH in the SS on the SCell, comprise:
when the SCell is determined to be in the dormancy state and the non-dormancy-state switching instruction for the SCell is received, switching the SCell from the dormancy state to a non-dormancy state and performing cross-scheduling on the PCell to monitor the PDCCH in the SS on the SCell.

4. The method of claim 1, further comprising:
receiving a further SCell-state switching instruction, wherein the further SCell-state switching instruction comprises a deactivation instruction for the SCell or a dormancy-state switching instruction for the SCell.

5. The method of claim 4, further comprising:
switching the SCell to the deactivation state or the dormancy state based on the further SCell-state switching instruction.

6. The method of claim 5, further comprising:
monitoring the PDCCH in the SS on the PCell when the SCell is in the deactivation state or the dormancy state.

7. A terminal device, the terminal device accessing a primary cell (PCell) and a secondary cell (SCell) and comprising:
a transceiver;
a processor coupled to the transceiver; and
a memory storing a computer program which, when executed, by the processor, causes the terminal device to:
monitor a physical downlink control channel (PDCCH) in a search space (SS) on the PCell, the SCell being in a deactivation state or a dormancy state;
receive an SCell-state switching instruction, the SCell-state switching instruction comprising an activation instruction for the SCell or a non-dormancy-state switching instruction for the SCell; and
based on the SCell-state switching instruction, perform state switching on the SCell and perform cross-carrier scheduling on the PCell to monitor the PDCCH in an SS on the SCell.

8. The terminal device of claim 7, wherein the processor configured to cause the terminal device to perform state switching on the SCell and perform cross-carrier scheduling on the PCell to monitor the PDCCH in the SS on the SCell is configured to execute the computer program to cause the terminal device to:
switch the SCell from the deactivation state to an activation state and perform cross-scheduling on the PCell to monitor the PDCCH in the SS on the SCell, when the SCell is determined to be in the deactivation state and the activation instruction for the SCell is received.

9. The terminal device of claim 7, wherein the processor configured to cause the terminal device to perform state switching on the SCell and perform cross-carrier scheduling on the PCell to monitor the PDCCH in the SS on the SCell is configured to execute the computer program to cause the terminal device to:
switch the SCell from the dormancy state to a non-dormancy state and perform cross-scheduling on the PCell to monitor the PDCCH in the SS on the SCell, when the SCell is determined to be in the dormancy state and the non-dormancy-state switching instruction for the SCell is received.

10. The terminal device of claim 7, wherein the processor is further configured to execute the computer program to cause the terminal device to:
receive a further SCell-state switching instruction, wherein the further SCell-state switching instruction comprises a deactivation instruction for the SCell or a dormancy-state switching instruction for the SCell.

11. The terminal device of claim 10, wherein the processor is further configured to execute the computer program to cause the terminal device to:
switch the SCell to the deactivation state or the dormancy state based on the further SCell-state switching instruction.

12. The terminal device of claim 11, wherein the processor is further configured to execute the computer program to cause the terminal device to:
monitor the PDCCH in the SS on the PCell when the SCell is in the deactivation state or the dormancy state.

13. A non-transitory storage medium storing a computer program which, when executed by a processor of a terminal device accessing a primary cell (PCell) and a secondary cell (SCell), causes the terminal device to:
monitor a physical downlink control channel (PDCCH) in a search space (SS) on the PCell, the SCell being in a deactivation state or a dormancy state;
receive an SCell-state switching instruction, the SCell-state switching instruction comprising an activation instruction for the SCell or a non-dormancy-state switching instruction for the SCell; and
based on the SCell-state switching instruction, perform state switching on the SCell and perform cross-carrier scheduling on the PCell to monitor the PDCCH in an SS on the SCell.

14. The non-transitory storage medium of claim 13, wherein the computer program executed by the processor to cause the terminal device to perform state switching on the SCell and perform cross-carrier scheduling on the PCell to monitor the PDCCH in the SS on the SCell is executed by the processor to cause the terminal device to:
switch the SCell from the deactivation state to an activation state and perform cross-scheduling on the PCell to monitor the PDCCH in the SS on the SCell, when the SCell is determined to be in the deactivation state and the activation instruction for the SCell is received.

15. The non-transitory storage medium of claim 13, wherein the computer program executed by the processor to cause the terminal device to perform state switching on the SCell and perform cross-carrier scheduling on the PCell to monitor the PDCCH in the SS on the SCell is executed by the processor to cause the terminal device to:
switch the SCell from the dormancy state to a non-dormancy state and perform cross-scheduling on the PCell to monitor the PDCCH in the SS on the SCell, when the SCell is determined to be in the dormancy state and the non-dormancy-state switching instruction for the SCell is received.

16. The non-transitory storage medium of claim 13, wherein the computer program is executed by the processor to further cause the terminal device to:
receive a further SCell-state switching instruction, wherein the further SCell-state switching instruction comprises a deactivation instruction for the SCell or a dormancy-state switching instruction for the SCell.

17. The non-transitory storage medium of claim 16, wherein the computer program is executed by the processor to further cause the terminal device to:
switch the SCell to the deactivation state or the dormancy state based on the further SCell-state switching instruction.

18. The non-transitory storage medium of claim 17, wherein the computer program is executed by the processor to further cause the terminal device to:
monitor the PDCCH in the SS on the PCell when the SCell is in the deactivation state or the dormancy state.
